(19) United States
(12) Patent Application Publication
(10) Pub. No.: US 2006/0207347 A1
(43) Pub. Date: Sep. 21, 2006

(54) Arrangement for measuring the torque of rotating machine parts

(76) Inventor: Manfred Kreuzer, Darmstadt (DE)

Correspondence Address: FASSE PATENT ATTORNEYS, P.A., P.O. BOX 726, HAMPDEN, ME, 04444-0726, US

(21) Appl. No.: 10/566,884

(22) PCT Filed: Mar. 18, 2005
(86) PCT No.: PCT/EP05/02892

§ 371 Date: Feb. 1, 2006

(30) Foreign Application Priority Data
Mar. 31, 2004 (DE) 102004015771.5

(51) Int. Cl. G01L 3/00

(52) U.S. Cl. 73/862.325

(57) ABSTRACT

The invention relates to an arrangement for the torque measurement of rotating machine parts with a strain measuring bridge (2) arranged on the rotor, which bridge consists of circuit-connected strain gages. The output signals of the strain measuring bridge (2) are amplified with an amplifier circuit (3) and are converted into frequency-proportional signals in a subsequent or downstream voltage-frequency converter (4). The invention is characterized in that the voltage-frequency converter is embodied as a so-called synchronous voltage-frequency converter (4), which is fed with a quartz-controlled frequency. For the suppression of the so-called frequency jitter, a follow-up synchronization circuit (PLL) (6) is provided after the synchronous voltage-frequency converter (4), which circuit suppresses the alternating frequency of the synchronous voltage-frequency converter (4), so that a frequency signal that is proportional to the analog strain measurement signal is produced at the output. These frequency-modulated measurement signals on the rotor side (14 are inductively transmitted via a transmitter circuit (9) onto a stator, on which an evaluating circuit is provided, which again produces analog signals or corresponding digital signals from the frequency-modulated measurement signals.

The invention relates to an arrangement for the rotational moment or torque measurement of rotating machine parts according to the preamble of the patent claim 1.

In torque pick-ups or transducers based on strain gage technology, the strain gages are usually applied on the rotor and circuit-connected to form a Wheatstone bridge, which supplies analog measurement signals that are proportional to the rotational moment or torque. By means of electronics on the rotor, these analog measurement signals are amplified, usually converted into a frequency or digital signal, and then inductively transmitted to the stator and further processed there. The conversion of the analog measurement signals into frequency or digital signals before the transmission to the stator primarily has the purpose of avoiding error influences through amplitude changes in the transmission.

The most typically used method is the conversion of the analog measurement signals into frequency modulated signals, because it permits a very simple evaluation with digital counter circuits, which are typical in the field of automation technology, especially for the rotational speed regulated motor controls.

Furthermore, the rotational speed arises as a frequency signal as a parallel measurement value, so that torque and rotational speed can be acquired and evaluated with similar-type electronic circuits. Because a frequency modulated torque signal has nearly an infinite resolution and can be carried out in high signal bandwidths, it has considerable advantages with respect to the accuracy, the measurement signal resolution and the signal bandwidths, relative to a transmission of digitally realized signals.

Moreover, the further processing of the digital values in fast closed-loop motor regulating circuits is not very widespread, because hardly any standardized interfaces exist for that purpose, and most field buses are too slow for these purposes. Furthermore, while a return conversion into frequency proportional signals is possible, it suffers from a non-linearity that is necessitated in principle, and suffers from the fact that the group delay times of the measurement string for closed-loop regulating circuit applications are often intolerably large.

An apparatus for the transmission of measurement signals via a transmitter from a rotor side to a stator side, and for the transmission of a supply voltage via the same transmitter from the stator side to the rotor side is known from the DE patent 28 46 583. The transmitter consists of a stationary winding connected with the stator and a rotatable winding connected with the rotor. The two windings are inductively coupled via an air gap. The supply voltage for a circuit that is connected with the rotor and that contains a measured value pick-up or sensor is produced in that the alternating voltage produced with the stator-side oscillator is supplied via the transmitter to a rotor-side rectifier with a stabilizer connected in circuit downstream from the rectifier. The measurement signal of the measured value pick-up is, after amplification, converted into a pulse train by a voltage-frequency converter, of which the output stage is connected to the rotor-side winding of the transmitter. The signal is tapped from a high-ohmic or high-resistance point of the stator side, and is provided to a demodulator. The output signal thereof corresponds to that of the voltage-frequency converter, that is to say a low frequency corresponds to a small measurement signal and a high frequency corresponds to a large measurement signal. Such voltage-frequency converters represent a function generator with controllable frequency, which consist of circuit-connected operational amplifiers with RC-elements, which comprise temperature dependent zero or null point and sensitivity errors as well as longterm drift due to aging. Especially in connection with a frequency modulation of middle frequencies above 100 kHz interferences arise in the form of a small time shift or offset in the receiver, which cause as so-called signal-jitter errors in the analog measurement signal.

Therefore, it is the underlying object of the invention to provide an arrangement for the rotational moment or torque measurement with frequency modulated measurement signal transmission, of which the accuracy is improved especially at higher transmittable signal bandwidths and high modulation frequencies, and is insensitive with respect to temperature-induced zero or null point and sensitivity errors.

This object is achieved by the invention set forth in the patent claim 1. Further developments and advantageous example embodiments of the invention are set forth in the dependent claims.

The invention has the advantage that a highly accurate longterm stable frequency conversion of the analog measurement signals is possible through the use of a synchronous voltage-frequency converter. Simultaneously, through a tracking or follow-up synchronization circuit (PLL circuit), the system-immanent so-called jitter effect is avoided, which would considerably impair especially the measurement accuracy of small analog measurement signals. Therefore, advantageously, also high bandwidths with high accuracy of the measurement signals are transmittable from the detected rotor-side to the stator-side.

In a particular embodiment of the invention with a high-frequency quartz-controlled modulation frequency, it is advantageous that thereby the transmission of interference frequencies are avoidable through filter circuits, which would otherwise lie in the range of the transmittable signal bandwidths and could falsify these measurement signals.

In a further particular manner of embodiment it is provided to produce the quartz-controlled modulation frequency on the stator side and to transmit it in a synchronized manner to the rotor, whereby additionally also interferences of the transmitter circuits are advantageously avoidable.

The invention will be described in further detail in connection with an example embodiment, which is shown in the drawing. It is shown by:

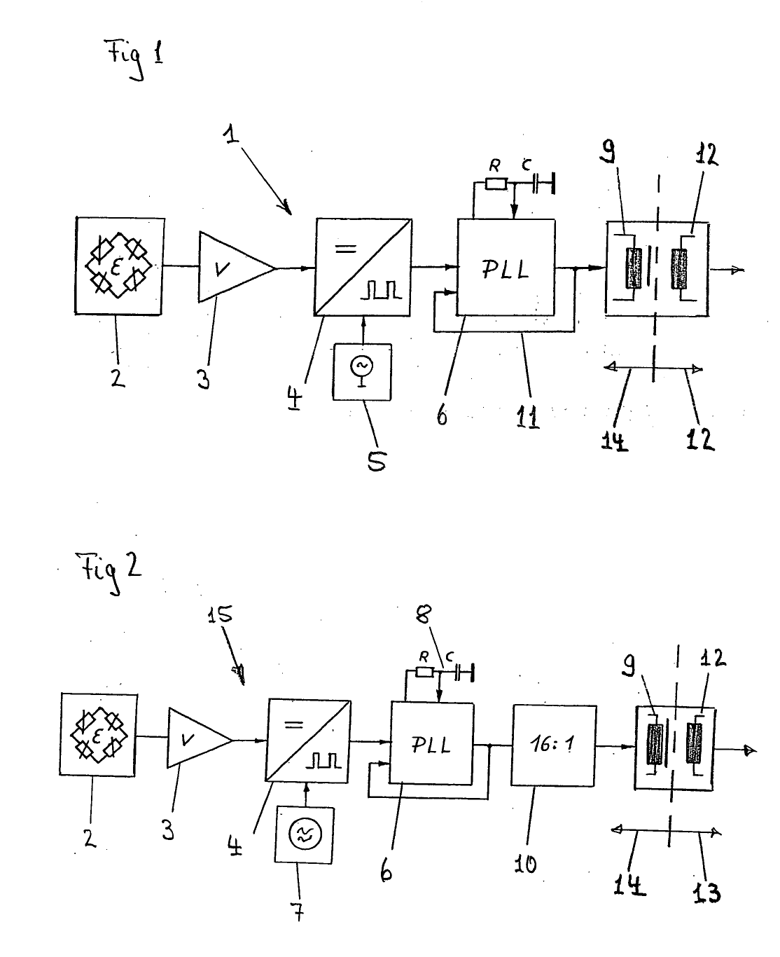

FIG. 1: a schematic illustration of a signal processing circuit for the frequency conversion, and

FIG. 2: a schematic illustration of a signal processing circuit for the frequency conversion with a frequency divider.

In FIG. 1 of the drawing there is shown a schematic signal processing circuit for the detection or acquisition and transmission of frequency modulated measurement signals from a rotor to a stator, which comprises a synchronous voltage-frequency converter 4 with a downstream or subsequent tracking or follow-up synchronization (PLL=Phase Locked Loop) 6 before or in front of the transmitter circuit 9.

The signal processing circuit 1 is part of an arrangement for the torque measurement of rotating machine parts, which is provided on a rotor for the detection or acquisition of torque signals, is converted into frequency modulated measurement signals and these are transmitted inductively and without contact to a stator for the measurement signal evaluation. For this purpose, torque transducer or pick-up elements in the form of strain gages are applied on a rotor and are circuit-connected to form a Wheatstone bridge and produce measurement signals as analog torque signals, which are proportional to the detected torque. These analog measurement signals at the output of the torque measurement bridge 2 are amplified in a conventional amplifier circuit 3 and are then provided to a voltage-frequency converter 4, which converts the analog measurement signals into a continuously variable frequency. In conventional voltage-frequency converters, the dynamic or time behavior thereof is determined only by RC-elements, which comprise linearity errors and are temperature dependent, and thus partially cause zero or null point and sensitivity errors through this frequency conversion. Therefore, a so-called synchronous voltage-frequency converter (SFU) 4 is provided for the inventive signal processing circuit 1. This synchronous voltage-frequency converter, instead of the time-determining RC-elements, requires a quartz-stabilized constant input frequency that is supplied from a quartz-controlled generator circuit 5. This quartz-controlled generator circuit 5 produces a constant input frequency in the form of rectangular pulses with a frequency of, for example, 200 kHz. In that regard, the analog measurement signal is compensated through a current of constant charge pulses, which are respectively generated in phase with the applied quartz frequency. This synchronous voltage-frequency converter 4 provides an accuracy that is one to two powers of ten higher relative to conventional frequency converters with time-determining RC-elements. This synchronous voltage-frequency converter 4 thus enables the construction of rotor electronics as signal processing circuits 1 with very high accuracies and resolutions.

However, such synchronous voltage-frequency converters 4 have an essential or considerable disadvantage for measurement signal conversion, which makes the use thereof seem basically unsuitable. Namely, the produced output pulses of the synchronous voltage-frequency converter 4 are produced only synchronously or simultaneously with a positive halfwave of the quartz signal, so that the synchronous voltage-frequency converters 4 can change their output frequency only in discrete frequency steps. With the provided quartz frequency of 200 kHz, the analog measurement signal shall preferably be represented from −100% to +100% frequency proportional as 50 kHz to 150 kHz (100 kHz+/−50 kHz). If now, for example, an analog input signal of +40% is assumed, then this corresponds to a frequency-proportional output signal of the synchronous voltage-frequency converter 4 of 120 kHz. Because the synchronous voltage-frequency converter 4 can itself output a pulse only simultaneously with a pulse of the applied quartz frequency, it can only produce integer (n) dividable output frequencies (f_{SFU}=f_{Quartz}/n) of the quartz frequency (f_{Quartz}) (in the given example, thus 200:1=200 kHz; 200:2=100 kHz; 200:3=66.6 kHz; 200:4=50 kHz) and thus does not offer the desired continuously tunable frequency range of 50 kHz to 150 kHz. Therefore, synchronous voltage-frequency converters at first glance seem to be completely unsuitable for the above-mentioned purpose. An output frequency (f_{SFU}) of 120 kHz can only be approximated by a continuous back-and-forth switching between 200 kHz and 100 kHz as an average value.

The alternating frequency with which the voltage-frequency converter switches between the frequencies 100 kHz and 200 kHz in order to produce 120 kHz on average is 40 kHz. The average frequency of 120 kHz output by the synchronous voltage-frequency converter thus has a system-necessitated unrest or agitation, that is referred to as so-called jitter. This frequency unrest leads to a sharp reduction of the possible measurement signal resolution, which is normally not acceptable for highly accurate torque measurements. Namely, in a frequency-proportional signal range from −100% to +100%=50 kHz to 150 kHz, 200 kHz correspond to an analog signal of +200% and 100 kHz correspond to an analog signal of 0%. This jitter effect, which is necessitated in principle, becomes especially critical in the proximity of 0% analog signal, because then the synchronous voltage-frequency converter 4 outputs a constant 100 kHz for a longer time and only jumps or switches to its neighboring possible frequencies of 66.66 kHz or 200 kHz with a low alternating frequency.

For the suppression of this system-necessitated jitter effect, a tracking or follow-up synchronization circuit 6 as a PLL-circuit (phase locked loop circuit) is provided in the signal processing circuit 1 at the output of the synchronous voltage-frequency converter 4. Thereby, the advantage of the high precision of the synchronous voltage-frequency conversion is utilized, and simultaneously the influence of the system-necessitated jitter is substantially suppressed. Namely, the PLL-circuit 6 compares its output frequency through the feedback branch 11 with the input frequency and adjusts itself to the average value of the input frequency. Because the PLL-circuit 6 has a lowpass characteristic, it cannot follow the rapid frequency switching of the synchronous voltage-frequency converter 4 and outputs at the output a calmed average frequency of, for example, 120 kHz, which is proportional to the analog measurement signal of 40% with high accuracy.

The respective frequency modulated output signal is thereafter provided to a known rotor-side transmitter circuit 9, which is inductively coupled with a transmitter circuit 12 on the stator, and transmits the frequency modulated measurement signal in a contact-less manner to the stator side 13. On the stator side 13, the amplitude of the transmitted signal frequency is usually regenerated in pulse former circuits, and is directly thereafter provided to evaluating circuits or supplied to a demodulation circuit, which converts the measurement frequency into an analog measurement signal. Simultaneously, the supply energy is inductively transmitted via the transmitter circuit 12 in a conventional manner from the stator side 13 to the rotor side 14, with which supply energy the measuring bridge circuit 2, the amplifier circuit 3, the synchronous voltage-frequency converter 4, as well as the tracking or follow-up synchronization circuit 6 are fed or supplied.

An improved embodiment of the signal processing circuit 1 is illustrated in FIG. 2 of the drawing. This signal processing circuit similarly contains a torque measuring bridge circuit 2, an amplifier circuit 3, a synchronous voltage-frequency converter 4 and a tracking or follow-up synchronization circuit 6, as according to FIG. 1 of the drawing. However, the synchronous voltage-frequency converter 4 is connected with a higher frequency quartz-controlled generator circuit 7, which supplies a quartz frequency in the MHz range (for example 3.2 MHz) to the synchronous voltage-frequency converter 4. Thus, in this example embodiment, the output frequency at the synchronous voltage-frequency converter 4 swings through the whole number or integer divider ratio between 1.6 MHz (0% analog signal) and 3.2 MHz (200% analog signal), in order to produce an average frequency of 1.92 MHz. Because the quartz frequency of the high frequency generator circuit 7 corresponds to 16 times the modulation frequency of 200 kHz according to FIG. 1, the alternating frequency at the output of the synchronous voltage-frequency converter 4 also increases by the factor of 16 and thus gives rise to an alternating frequency of 640 kHz, which is then averaged by the following PLL-circuit 6 that is also of 16-fold wider bandwidth, and is thereby obtained as a frequency proportional output frequency of 1.92. Thereby, the dynamic range of the faster PLL-circuit is prescribed by switching-in correspondingly dimensioned RC-elements 8.

Connected to the fast PLL-circuit 6, there is provided a frequency divider circuit 10, which divides down the calmed output frequency in a ratio of 16:1, so that then, with a prescribed analog signal of 40%, similarly again a frequency modulated output signal of 120 kHz is outputted, which is inductively transmittable via the transmitter circuit 9 from the rotor side 14 to the stator side 13. Because the frequency switching of the synchronous voltage-frequency converter 4 occurs extraordinarily fast in this embodiment, these frequencies lie far above the signal bandwidth of interest of the measurement signal and can be suppressed through corresponding filter circuits, so that thereby the measurement signal unrest and thus also the measurement accuracy can no longer be impaired.

In the signal processing circuit 15 according to FIG. 2 of the drawing, with the high frequency modulation voltages of over 3 MHz, embodiments are also possible in which the synchronous voltage-frequency converter 4 is further arranged on the rotor side 14, while the tracking or follow-up synchronization circuit 6 is provided after the transmitter circuit 12 on the stator side 13. Thereby, advantageously, also unfavorable additional jitter interferences in the frequency transmission from the rotor to the stator are substantially avoidable, whereby the measurement accuracy is increased. Similarly, also the frequency stabilized carrier frequency can be produced on the stator side 13 and can be provided to the synchronous voltage-frequency converter circuit 4 via the supply power transmitter. This carrier frequency can then simultaneously be used for the synchronization of the stator-side pulse former stages, whereby a jitter-free, i.e. measurement error free, transmission is made possible without great effort or expense.

1. Arrangement for the torque measurement of rotating machine parts with a strain measuring bridge (2) arranged on the rotor, the output signals of which strain measuring bridge are amplified and converted in a voltage-frequency converter (4) into a frequency-proportional signal and are transmitted by means of a transmitter circuit (9) to a stator, characterized in that the voltage-frequency converter (4) is embodied as a synchronous voltage-frequency converter, after which a follow-up synchronization circuit (PLL) (6) is circuit-connected for the suppression of the so-called frequency jitter.

2. Arrangement for the torque measurement according to claim 1, characterized in that the synchronous voltage-frequency converter (4) is driven with a high quartz-controlled frequency, which comprises a multiple of the required carrier frequency, which is provided for a prescribed signal bandwidth, whereby the follow-up synchronization circuit (PLL) (6) is followed by a frequency divider circuit (10), which divides down the output frequency by the multiple.

3. Arrangement for the torque measurement according to claim 2, characterized in that the synchronous voltage-frequency converter (4) is arranged on the rotor side (14), while the follow-up synchronization circuit (PLL) (6) is provided on the stator side (13), whereby the quartz frequency is produced on the stator side (13) and is inductively transmitted in a synchronized manner to the rotor side (14) with the aid of the transmitter circuit (12) and is supplied to the synchronous voltage-frequency converter (4).
